(19) United States
(12) Patent Application Publication
(10) Pub. No.: US 2007/0053188 A1
(43) Pub. Date: Mar. 8, 2007

(54) LED ultraviolet air sanitizer light fixture

(75) Inventors: Richard D. New, Plano, TX (US); Todd Schoel, Carrollton, TX (US)

Correspondence Address: JENKENS & GILCHRIST,;A PROFESSIONAL CORPORATION, Suite 3700, 1445 Ross Avenue, Dallas, TX, 75202, US

(73) Assignee: LUMINATOR HOLDING, L.P.

(21) Appl. No.: 11/220,171

(22) Filed: Sep. 6, 2005

(51) Int. Cl. F21V 23/04

(52) U.S. Cl. 362/276

(57) ABSTRACT

A lighting fixture and lighting system for a transportation vehicle is disclosed that provides color variations for lighting the passenger cabin of an airplane, train, bus or other type of transportation vehicle. The lighting fixture and system further provide ultraviolet light that helps to disinfect the circulating air in the passenger cabin. A fixture in an exemplary lighting system provides visible light for lighting up the passenger cabin and germicidal ultraviolet light directed toward or into an output vent(s) of the air circulation system of the passenger vehicle. The ultraviolet light is segregated from the visible light such that ultraviolet light is only directed toward or into the circulation vents of the vehicle's air circulation system.

### BACKGROUND OF THE INVENTION

1. Field of the Invention

The present invention is directed to an ultraviolet LED light source that provides air sanitation in combination with a visible light source that provides lighting of an area.

2. Background of Related Art

Lighting systems have been used to light the interior of rooms and transportation vehicles for quite some time. Lighting systems based on LEDs have the advantage in that they can be controlled to vary both their color and brightness. Through an appropriate combination of these two parameters, subtle lighting effects such as sunrise, sunset, and mood lighting can be achieved. Because of this and other advantages, LED based lighting systems are rapidly replacing traditional fluorescent lighting systems in a number of environments, including transportation, military, commercial and home environments.

Furthermore ultraviolet light, produced by low pressure mercury vapor or mercury arc lamps has been used in various industries, such as food preparation and clean rooms to emit ultraviolet radiation. The ultraviolet light is highly effective at deactivating microorganisms including bacteria, viruses, yeasts and molds. Ultraviolet germicidal lamps are effective in a growing number of applications where control of microorganisms is important.

It is important to understand that that ultraviolet light can be destructive to many plastics and polymers. Ultraviolet light can also have negative effects on people. Plastics and polymers can become degraded and brittle under extended exposure to ultraviolet light. Human's skin is damaged when subjected to extended exposure to ultraviolet light or radiation.

In the past various air cleaners and air sanitizers, for both commercial and consumer use have used ultraviolet light to aide in the sanitization of air. All of these devices incorporate blowers or negative ions to move air past the ultraviolet lamps. In the prior devices, the ultraviolet lamps are located on the interior of the device or enclosed within the device to reduce or eliminate ultraviolet light exposure outside of the air sanitizer device. Furthermore, these prior art air sanitizers do not provide visible light to a room or other environment.

What is needed is a lighting fixture that provides both visible light and air sanitizing ultraviolet light and can be used in a number of environments, including transportation, military, commercial and home environments.

### BRIEF SUMMARY OF THE INVENTION

The present exemplary embodiments of the invention provide a lighting fixture. The exemplary lighting fixtures combine a visible light source that directs visible light in a first direction with an ultraviolet LED array that directs ultraviolet light in a second direction. The exemplary lighting fixture also includes a control unit that controls the intensity and/or color of the visible light as well as the intensity of the ultraviolet light emitted from the ultraviolet LED array.

Embodiments of the invention provide illumination of the interior of a transportation vehicle, such as an airplane, bus or train, which also provide virus, mold, bacteria and germ killing ultraviolet light directed toward the output vents of the vehicles circulation system.

Other embodiments of the present invention can include smoke, carbon dioxide, airflow or motion sensors such that the embodiment can be used in a lavatory of a transportation vehicle.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is an illustration of an interior of an aircraft or train wherein an embodiment of the present LED ultraviolet air sanitizer light fixture and system is installed;

FIG. 2 is a exemplary embodiment of an LED ultraviolet air sanitizer light fixture;

FIG. 3 is another exemplary embodiment of an LED ultraviolet air sanitizer light fixture;

FIG. 4 is a block diagram of an exemplary embodiment of an LED ultraviolet air sanitizer light fixture;

FIG. 5 is another exemplary embodiment of an LED ultraviolet air sanitizer light fixture;

FIG. 6 is yet another exemplary embodiment of an LED ultraviolet air sanitizer light fixture; and

FIG. 7 is a block diagram of an embodiment of a light fixture system incorporating LED ultraviolet air sanitizer light fixtures.

Although various embodiments of the method and apparatus of the present invention have been illustrated in the accompanying Drawings and is described in the following Detailed Description, it will be understood that the invention is not limited to the embodiments disclosed, but is capable of numerous rearrangements, modifications and substitutions without departing from the invention as set forth herein.

### DETAILED DESCRIPTION OF THE INVENTION

Embodiments of the present invention use ultraviolet LEDs as an ultraviolet light source. The ultraviolet light is in the ultraviolet-B range of about 280 to 315 nm, and the ultraviolet-C range of about 100 to about 280 nm, range that provides air sanitation by damaging the DNA molecules in bacteria, viruses, molds, yeast, and other microorganisms preventing them from replicating, surviving, creating odors, or causing harm. Embodiments of the present invention further provide visible light in the form of halogen, fluorescent, LED, incandescent, or other type of light or color producing bulb or lamp. The two light sources are part of a lighting fixture and are separately controlled by a control module. Embodiments of the invention are for use in closed areas. A closed area may be inside the passenger compartment of a train, airplane, bus, or lavatory. A closed area also includes places where one is not able to open a window to get fresh air into the room or area. For example, on many airplanes and trains the windows cannot be opened by a passenger. Furthermore, lavatories on airplanes and trains do not have windows that open.

In general terms, the visible lighting source, located on an outer surface of the fixture, provides general illumination from the fixture in the direction of a given area of a room or passenger compartment of an airplane, train or bus or other transportation vehicle (herein a “transportation vehicle”). The visible lighting source may be covered by a clear or translucent cover that acts as light diffuser or protects the lights from dust and the environment. The ultraviolet LEDs may be placed on the same circuit board, but are generally placed on a separate or nearby outer portion of the fixture and provide ultraviolet illumination in the general direction of air being output from a circulation system providing air or conditioned air to the room or passenger compartment of the transportation vehicle (i.e. the train, bus, airplane or other transportation vehicle). The ultraviolet LEDs can be directed toward wherever there is air flow in the form of return or conditioned in a passenger cabin of a transportation vehicle. The ultraviolet light may be directed in the desired direction through use of a deflector shield. Furthermore, in some embodiments the ultraviolet light may be directed in substantially the same direction as the light from the visible light source.

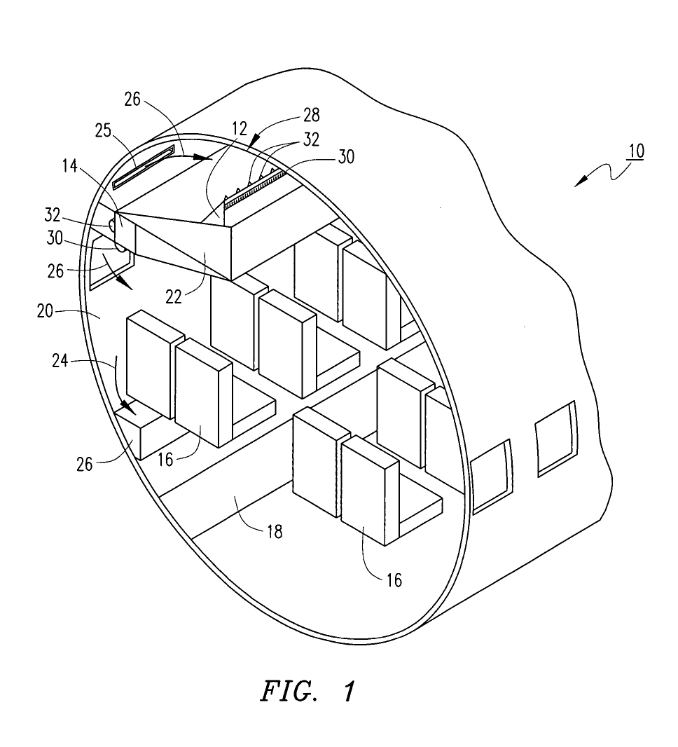

Referring now to FIG. 1 an illustration of an interior 10 of an aircraft or train wherein embodiments of the present LED ultraviolet air sanitizer light fixture 12, 14 and system are depicted. There are seats 16 (the seatbacks are shown) where passengers sit. On one side of the seats 16 is an isle 18 down the center or near center of the interior 10. On the other side of the seats 16 is the side of the passenger cabin or wall 20. In an aircraft or plane the wall 20 may have windows to allow the passenger to look outside of the transportation vehicle. Above the passenger seats 16 is some type of storage bin 22 where a passenger can store luggage or other items that where carried onto the transportation vehicle. Air circulation is provided within the passenger cabin interior 10 by an air circulation system such as a heating/air conditioning system (not specifically shown). Return air flow 24 may be received by a return air vent 26 along the floor of the passenger cabin interior 10. Heated or conditioned air flow 26 flows out of a vent 25 across the top of the storage bin 22 and across the ceiling 28. The heated or conditioned air 26 coming out of another vent 25 may also flow down the wall or sidewall 20 toward the passengers in seats 16.

A first embodiment of the present LED ultraviolet air sanitizer light fixture 12 mounted either on top of the storage bins 22 or on the ceiling 28. Visible light from the fixture 12 provides a wash light or indirect lighting onto the ceiling 28 of the passenger cabin 10. The visible light in this embodiment is produced by an array of LEDs 30. The array of LEDs 30 can all be white light LEDs, a RGB or a RGBW array of LEDs. A controller (not specifically shown) inside the fixture 12 is programmed to control an RGB array of LEDs to provide substantially any color of visible light to the passenger cabin 10. The array of LEDs 30 are placed on one surface of the fixture so that, when the fixture 12 is mounted to the top of the storage bins 22 or to the ceiling 28, visible light is directed toward the passenger cabin 10 or washed onto the passenger cabin ceiling 28 as indirect lighting.

Furthermore, the first embodiment of the present LED ultraviolet air sanitizer light fixture 12 has an array or plurality of ultraviolet LEDs 32 mounted on the fixture 12. The ultraviolet LEDs 32 are controlled by the controller within the fixture and provide ultraviolet light in the ultraviolet-C range in order to destroy or disable airborne microorganisms such as bacteria, viruses, yeast and mold. The controller is programmed to control the intensity of the ultraviolet light emitted from the ultraviolet LEDs 30. The ultraviolet LEDs are positioned on the fixture such that they are directed to emit ultraviolet light into the airflow 26 of the conditioned air coming into the passenger cabin. The ultraviolet LEDs 30 can be directed into the vent 25 so that the ultraviolet radiation does not damage any of the plastic or other materials in the passenger cabin 10. By directing the ultraviolet light into the vent 25, the ultraviolet light impinges on the air flow 26 as it moves out of the vent 25 and into the passenger cabin 10.

In order to keep the ultraviolet light from impinging on any locations other than in the direction of the vent 25, the fixture 12 may include a shield (not specifically shown in FIG. 1) that can reflect, redirect or block the ultraviolet light emanating from the ultraviolet LEDs from illuminating anything except the vent 25 output airflow 26 and areas thereabout.

Another embodiment of an exemplary LED ultraviolet air sanitizer light fixture is fixture 14, the fixture 14 is mounted either between the storage bin 22 and the side wall 20 of the passenger cabin 10 or under the storage bin 22 and next to the wall 20 as shown in FIG. 1. In this configuration the visible illumination from the array of LEDs 30 provides a downwash of indirect lighting on the wall 20 of the passenger cabin 10. Again, the ultraviolet LEDs 32 are positioned on the fixture 14 such that ultraviolet light emitted is directed back toward the source of the airflow, the vent 25, and not toward the interior of the passenger cabin 10. The ultraviolet LEDs 32 are shown to be installed on a surface other than the surface where the visible light LEDs 30 are installed.

Furthermore, it is not necessary that an array of visible light LEDs 30 be the only source of visible light from an exemplary fixture 12, 14. Fluorescent, incandescent, halogen, neon, mercury vapor or any other visible light generating bulb or device can be used or substituted to produce the visible light up wash or down wash indirect lighting on the ceiling 28 or wall 20 in a passenger cabin 10. Furthermore, the control circuitry inside the fixture 12, 14 allows the two light sources, visible and ultraviolet, to be controlled independently. For example, the visible light can be brightened, dimmed, or have the color of light output changed while the intensity of the ultraviolet light output is separately controlled.

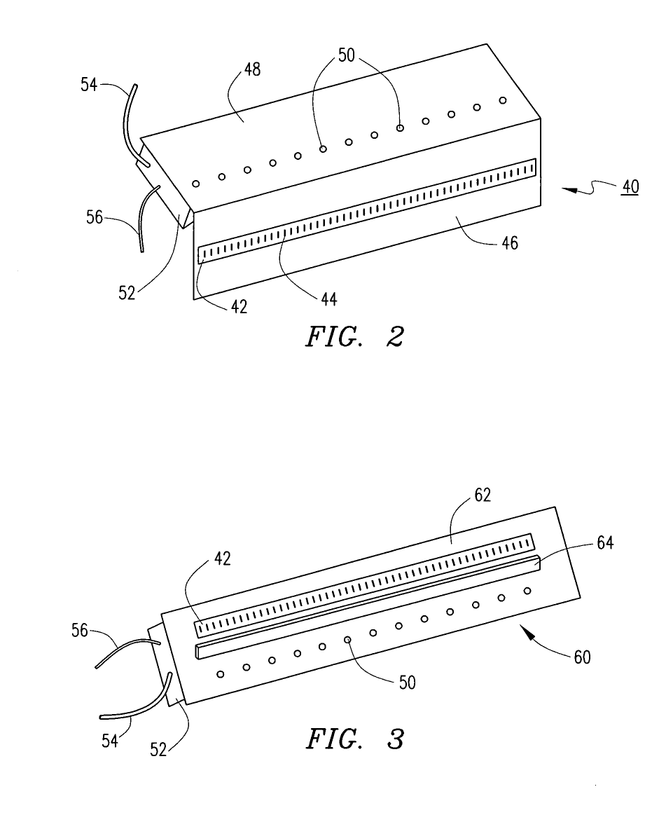

Referring now to FIG. 2 where an exemplary embodiment of the present LED ultraviolet air sanitizer light fixture 40 is depicted. This fixture 40 provides a visible light source 42. The visible light source can be a variety of visible light sources such as fluorescent, incandescent, neon, mercury vapor, halogen, or LED based lighting. The visible light source 42 depicted in FIG. 2 is an array of colored LEDs 44. The exemplary array of LEDs 44 are red, yellow/green and blue such that they provide an RGB LED array of LEDs running the length of the fixture 40. The visible light source 40 is mounted on one surface 46 of the fixture 40. The array of RGB LEDs 44 can provide visible light in any color, hue, or intensity necessary to light, provide a visual mood or wash light in, for example, the passenger cabin of a transportation vehicle. RGBW LED arrays can also be used.

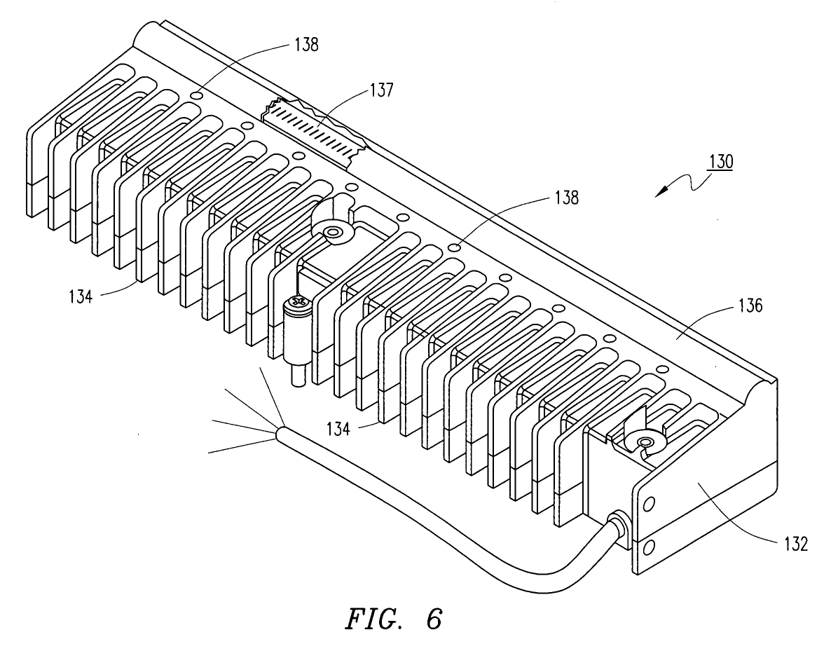

On another surface 48 of the fixture 40 are a plurality of ultraviolet LEDs 50. The second surface 48 of the fixture is non-coplanar or canted with respect to the first surface 46 thereby providing some separation of the visible light emitted from the visible light source 42 and the ultraviolet light from the ultraviolet LEDs 50. The ultraviolet light emitted from the LEDs 50 is to be directed toward an air flow source and is used to help disinfect the air within the air flow. As generally shown in FIG. 5, The visible light emitting LEDs and/or the ultraviolet emitting LEDs can be arranged in circular, star shaped, random, geometric or squiggly patterns.

A controller circuit 52 is contained within the fixture 40. The controller 52 is programmed to separately control the visible light source 42 and the ultraviolet LEDs 50. For the visible light source 42 the controller 52 controls the intensity, color, hue, and the amount of time it takes to change from one color setting to another. For the ultraviolet light source the controller 52 controls the intensity of the ultraviolet light produced. The controller has connections 54 for a power source. The fixture 40 can operate on DC voltages found in a bus or automobile, international voltages such as 120 v/60 Hz, train voltages, or airplane voltages such as 115 v/400 Hz. The controller 52 has a system connection 56 for connecting the fixture to a system control panel (not shown) or to other fixtures in the transportation vehicle so that various fixtures orchestrated to operate together.

FIG. 3 depicts another exemplary embodiment of the present LED ultraviolet air sanitizer light fixture 60. Here the visible light source 42 and the plurality of ultraviolet LEDs 50 are mounted on the same surface 62 or nearly parallel surface of the fixture 60. The visible light source 42 is mounted along one edge or near and along one edge of the surface 62. Along or near an opposing edge of the same surface 62, the ultraviolet LEDs 50 are placed in a spaced formation down the length of the fixture 60. A deflector or shield 64 is attached to or is part of the surface of the fixture 60 and extends the length of the fixture between the visible light source 42 and the ultraviolet LEDs 50. The shield 64 acts to isolate and direct the ultraviolet light to portions of a transportation vehicle's passenger cabin where air flow is present in order to help disinfect the air in the passenger cabin. Furthermore, the shield 64 keeps the ultraviolet light from illuminating into the passenger cabin where it could prematurely degrade plastics and other materials as well as shine on unsuspecting passengers who do not want to be irradiated with ultraviolet light.

The shield 64 can be made out of a variety of materials and have a variety of physical properties. For example, the shield can be made out of metal, glass or a plastic or polymer that is not ultraviolet sensitive. The shield can reflective or be opaque to ultraviolet light but allow visible light through. Other possibilities include using a clear defector 64 with an ultraviolet blocking coating on the defector 64 to prevent the ultraviolet light from passing through the deflector 64. Therefore, the ultraviolet LEDs 50 could be in the line of sight of the passengers, but the ultraviolet light would be blocked by the shield 64 even though the shield is clear.

The fixture 60 also includes a control module or control circuitry 52 for controlling the two light sources (visible and ultraviolet) separately. A power line 54 is provided to power the fixture 60. Also a system control line 56 is connected to the control module 52 so that the fixture 60 can by synchronized with other fixtures and centrally controlled by a system control console (not shown). The control module or control circuitry 52 can be divided into multiple circuit boards or modules such that one circuit board controls the RGB array of LEDs 42 (i.e. the visible lights), a second circuit board controls the ultraviolet LEDs 50, a third circuit board may convert the input power from power line 34 into power that is useable by the circuitry in fixture 60. Yet another circuit may communicate with the system control console in a wired or wireless manner. This circuit may interpret signals from the system control console and communicate with the first and second circuit boards to adjust the visible or ultraviolet light output from the fixture 60 accordingly.

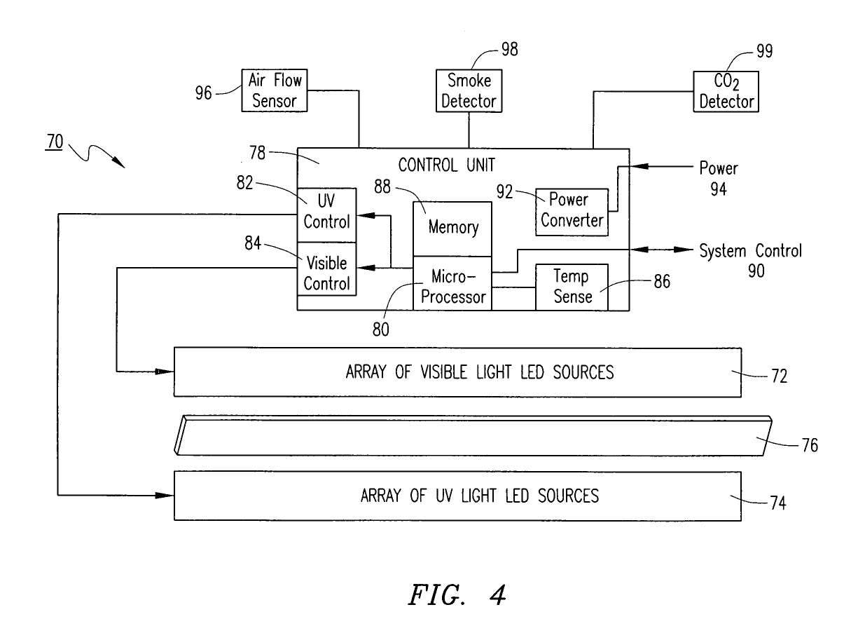

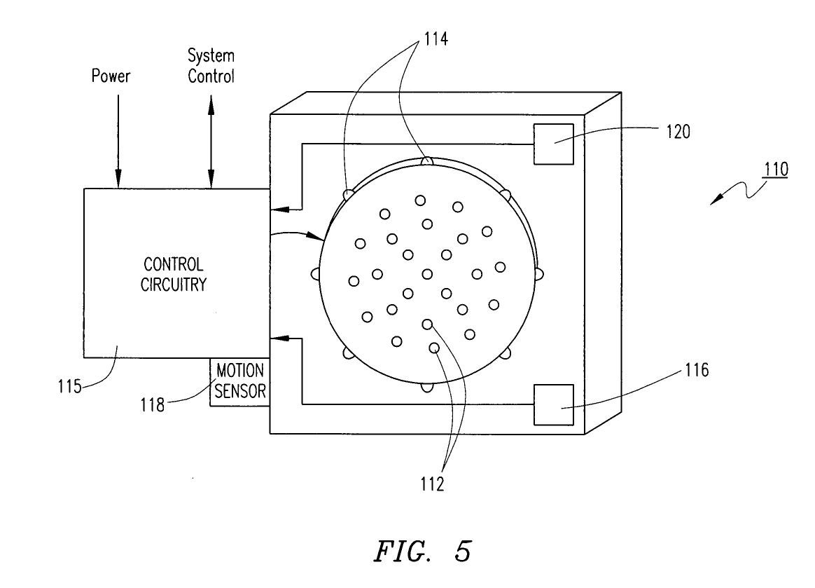

FIG. 4 is a block diagram of an exemplary ultraviolet LED air sanitizer light fixture 70 in accordance with the present invention. A visible light or light array 72 is shown. The visible light or light array 72 may comprise light sources that produce white light, colored light or, for example, an RGB light source that can produce visible light in substantially any color by combining the output of red, yellow/green and blue LEDs under microprocessor control. Other light sources for the visible light 72 can be high intensity lights, fluorescent, incandescent, neon, halogen, mercury vapor, etc. An LED RGB light source can be used to enhance the environment of a passenger cabin of an airplane, train or bus through the use of advanced color lighting to set moods, tones and lighting designs.

A second light source is an ultraviolet light source 74. The ultraviolet light source 74 is in the form a plurality of ultraviolet LEDs. The ultraviolet light source 74 can also be an array of ultraviolet LEDs, one more mercury vapor lamps or other sources of ultraviolet light. The ultraviolet light produced by the ultraviolet light source 74 is in the ultraviolet-C range, being light having a wavelength in the range of about 200 to 280 nm. Ultraviolet light in this wavelength range is used to disinfect airflow near the ultraviolet light source. The ultraviolet light damages the DNA molecules in bacteria, viruses and other micro-organisms preventing them from replicating and surviving to cause harm.

The ultraviolet light source 74 is mounted on the fixture 70 so that when the fixture is mounted or installed in the passenger cabin of an airplane, train, bus or other environment, the ultraviolet light that emanates from the fixture is directed toward the airflow coming out of an air vent that supplies circulation air to a passenger cabin. At the same time, the visible light source 72 is directed to aide in the illumination of the passenger cabin. In some embodiments the ultraviolet light source and the visible light source are directed in substantially the same direction.

If the two light sources are not placed to illuminate in different directions or in a canted relationship to each other on the fixture 70, then a shield or deflector 76 may be necessary to stop ultraviolet light from illuminating the passenger cabin or the passengers. The shield 76 keeps the ultraviolet light from illuminating the passenger cabin where it could prematurely degrade plastics and other materials as well as shine on unsuspecting passengers who do not want to be irradiated with ultraviolet light. The shield 76 can be made out of a variety of materials and have a variety of physical properties. For example, the shield can be made out of metal, glass or a plastic or a polymer that is not ultraviolet sensitive. The shield 76 can be reflective or be opaque to ultraviolet light but allow visible light pass through. Other possibilities include using a clear defector 76 with an ultraviolet blocking coating on the defector 64 to prevent the ultraviolet from passing through the deflector 76. Therefore, the ultraviolet light source 74 could be in the line of sight of the passengers, but the ultraviolet light would be blocked by the shield 76.

The control unit or control module 78 comprises circuitry for controlling the visible light source 72 and the ultraviolet light source 74. The control module 78 may operate under microprocessor control via microprocessor 80. The microprocessor 80 may control the ultraviolet control circuitry 82 in order to vary the intensity of the possible ultraviolet light output from zero to one hundred percent. The microprocessor 80 may also control the visible light control circuitry 84 to control the intensity, color, hue, duty cycle, time to increase or dim intensity and/or, time to change from one color to another color. Furthermore, if an RGB array of LEDs are being used as the visible light source, the microcontroller by sense temperature via a temperature sensor 86 and adjust the duty cycles and intensities of the colored LEDs in the RGB LED array so that color emitted from the array does not visually change due to temperature changes. It is well known that colored LEDs are temperature sensitive and, when provided the same input, will produce a varying intensity output as the temperature of the LED varies. Such color variations are compensated for by using microprocessor control 80.

A memory device 88 is connected to the microprocessor to store firmware for operating the microprocessor as well as for storing a data table for providing preprogrammed lighting setups for the fixture 70. Multitudes of lighting setups can be stored at predetermined memory address locations. The microprocessor 80 addresses the memory 88 and reads the lighting setup at the address. The microprocessor then prescribes the lighting setup to the visible and/or the ultraviolet lighting arrays 72, 74. The microprocessor reads the temperature from the temperature sensing circuit 86 and uses the sensed temperature to adjust the visible lighting control so that if a plurality of fixtures 70 are in the passenger cabin 10, and are all operating under common control, they will all produce the same lighting effect or appropriate choreographed lighting effect throughout the passenger cabin.

A system control connection 90 is provided to the fixture 70 and is in electrical communication with the microprocessor 80. The system control connection 90 provides a signal from a system control panel (not shown) that establishes control over a plurality of fixtures 70 throughout a passenger cabin 10. The system control panel may provide an address or other data that is read by the microprocessor 88. The microprocessor, in turn, reads the appropriate contents from the memory 88 and then controls the visible and the ultraviolet portions of the light sources 72, 74. In some embodiments of the present invention, instead of a system control connection 90, the communication between the system control panel and each fixture is done in a wireless manner using a broadband radio frequency.

The power circuitry 92 is a power converter that is adapted to receive electrical power from the power connection 94 and convert the power to a usable voltage and current for the use by components on the fixture 70 and within the control module 78. As such, the power circuitry 92 can be designed to convert any international household voltage, aircraft, bus, or train voltage to a working voltage or voltages for the fixture 70.

Other circuitry that may be found on exemplary fixtures 70 in accordance with embodiments of the present invention include an airflow sensor 96 that is placed near the ultraviolet light source 74 to sense if air flow is present. If no air flow or if the airflow is below a predetermined amount of air flow, the air flow sensor 96 will provide a signal to the microprocessor 80 or in other embodiments to the ultraviolet control circuitry 82. In response thereto, the ultraviolet light source 74 will not be illuminated until enough airflow is present or sensed by the air flow sensor 96.

A smoke detection device 98 and or a carbon dioxide detector 100 may also be incorporated into the fixture 70. The smoke detector 98 and carbon dioxide detector 99 can be placed near the output air flow of the circulation vent to constantly monitor for smoke or carbon dioxide quantities in the passenger cabin air. If smoke or more than a predetermined amount of carbon dioxide is sensed in the passenger cabin circulation air, then the control module 78 can sound an alarm or send a signal to the system control panel indicating an alarm condition.

It should be noted that a fan or blower is not incorporated into exemplary embodiments of the present invention because fixtures 70 are position near the output vents of the circulation system in a transportation vehicle and thus does not require a fan or blower incorporated thereon.

Referring now to FIG. 5, another embodiment of an LED ultraviolet air sanitizer light fixture 110 in accordance with the present invention is depicted. Here a visible LED array 112 and an ultraviolet LED array 114 are not formed into a particular array pattern. In other words the arrays do not have to be a linear array or a rectangular array pattern (e.g. n×m array). For example, the ultraviolet array may be in a circular, geometric, or random shaped array. There is however an importance to the relationship between the visible LED array 112 and the ultraviolet LED array 114. Although the ultraviolet and visible light emitting LEDs 112, 114 can be combined into a single array, the light emitted from the two different types of LEDs must be segregated or separated. The illumination separation is important so that the ultraviolet light does onto degrade plastics and polymers in and about the passenger cabin of an aircraft, train, or bus.

In FIG. 5, the visible LEDs 112 are disposed in a circular or spotlight pattern on the fixture 110. The ultraviolet LEDs 114 are arranged about the outer periphery of the visible light LEDs 112. The ultraviolet LEDs 114 are directed in directions substantially perpendicular to or angularly away from the visible light emitted from the visible light LEDs 112. This fixture 110 can be used as a lavatory lighting fixture mounted on the ceiling of a lavatory for, among other places, an airplane, train or bus lavatory. The fixture 110 provides visible light for the passenger when they are in the lavatory, an also provides ultraviolet germicidal light to help kill germs, viruses and mold in the lavatory. A shield, not specifically shown, would be circumferentially placed about the visible LEDs 112 and block ultraviolet light from shining on a passenger or into the lavatory. A motion sensor 118 or IR sensor may be used to detect whether a passenger is in the lavatory. If passenger is not in the lavatory, the ultraviolet LEDs may shine in the lavatory for a predetermined amount of time to help disinfect the lavatory. If a passenger is in the lavatory, the visible LEDs 112 will be on, but the ultraviolet LEDs can be off (in this configuration because no shield to separate the ultraviolet light and visible light is required). Circulation air in the lavatory can be directed at or near the fixture 110 to further aid the ultraviolet germicide process.

Like the other various embodiments of the invention control circuitry 115 controls the fixture 110. Furthermore, the fixture 110, can include a smoke detector circuit 116 to detect for smoke or if a passenger is smoking in the lavatory. A carbon dioxide sensor 120 can also be incorporated.

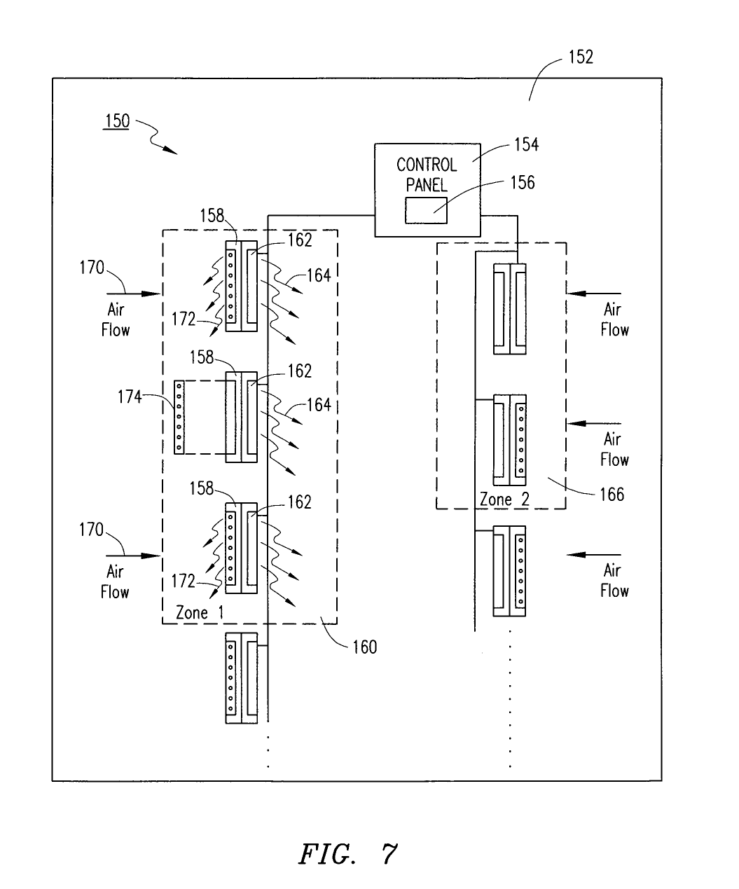

FIG. 6 is another embodiment of the present invention. Here the fixture 130 has a housing 132 that is made of a metal such as aluminum or another suitable metal or alloy. The housing 132 could also be made of a polymer or plastic that is ultraviolet resistive. The housing 132 has cooling fins to help dissipate heat generated by the control and power circuitry within the housing 132. The visible light source is underneath a cover or lens 136. The cover or lens 136 protects the visible light source and can also be used to mix or diffuse the visible light emitted from the visible light source, for example, to mix the visible light emitted from an RGB array of LEDS 137 underneath the cover 136.

Ultraviolet LEDs 138, in this embodiment, are mounted at predetermined intervals along a surface extending the length of the fixture 130. The ultraviolet LEDs 138 can be mounted in an array on a circuit board or directly on or in the housing 132. A shield, as shown in other embodiments of the invention, can be positioned between the ultraviolet LEDs and the visible light source under the cover 136 in order keep ultraviolet light emitted from the ultraviolet LEDs from being directed in the same direction as the visible light emitted from the visible light source.

The fixture 130 is to be placed in a passenger cabin (as shown in FIG. 1) so that airflow from the cabin circulation system blows past the ultraviolet LEDs 138 and also cools the cooling fins 134.

FIG. 7 is a block diagram of an embodiment of a light fixture system 150 incorporating LED ultraviolet air sanitizer light fixtures. The system is inside a passenger cabin area 152 of an aircraft, train, bus, boat, or other transportation vehicle. A controller box or panel 154. The controller panel 154 has an operator interface 156 so that, for example, a flight attendant on an aircraft can pick, select, or adjust the lighting and light sequence that will run in the aircraft. The selected lighting sequence is communicated to the exemplary fixtures 158. The plurality of lighting fixtures 158, after receiving instructions from the control panel 154 operate in unison or in concert to create an overall lighting effect in a predetermined area or zone 160 the cabin of the aircraft, train or bus. The overall lighting effect 164 from the visible lighting sources 162 can vary in brightness, intensity and a spectral range of color and lighting warmth. The visible lighting can be controlled to provide different hues of light depending on the time of day, desired mood or activities (i.e. eating, watching movie, sleeping) that are prevalent within the passenger cabin 152.

Separate zones (e.g. zone1 160, and zone2 166) can be established so that different visible lighting effects can be provided to different sections or areas of a passenger cabin. For example, zone1 160 may be in the first class section of a train or airplane, while zone2 166 may be in the business class section of the passenger cabin.

The fixtures 158 are positioned so that the ultraviolet LEDs or array of ultraviolet LEDs 168 are directed to illuminate the airflow 170 from the transportation vehicle's circulation system. Illumination of the airflow 170 with ultraviolet light 172 has a germicidal effect by damaging the DNA molecules in bacterial, viruses and other micro-organisms thereby preventing them from replicating and surviving to cause harm to the passengers on the transportation vehicle. The intensity of the ultraviolet light emitted from the ultraviolet LEDs 168 is also initially controlled by the control panel 154.

In some embodiments of the present invention, an array or module of ultraviolet LEDs 174 can be removably attached to the fixture 158. Removal of the ultraviolet LED array 174 is advantageous when the fixture 158 is placed in an area of the passenger cabin where there is no airflow 170 or where the ultraviolet light emitted from the fixture 158 will be directed in an undesirable direction (i.e. toward a passenger or a surface in the passenger cabin that would be degraded by the ultraviolet light.

In another embodiment of the present invention the control panel or box 154 communicates with the plurality of fixtures 158 in various zones 160, 166 in a wireless manner, for example, via radio frequency, spread spectrum or optical communications. By using radio frequency communications, wires connected each of the fixtures 158 to the control panel are no longer needed. Furthermore, in a passenger train, wherein there are multiple passenger cars, the wireless technique will simplify installation and the wiring of the overall system.

While particular embodiments and applications of the present invention have been illustrated and described, it is understood that the invention is not limited to the precise construction and compositions disclosed herein and that various modifications, changes, and variations may be apparent from the foregoing descriptions without departing from the spirit and scope of the invention as defined in the appended claims.

What is claimed is:

1. A lighting fixture comprising:
a visible light source, attached to said lighting fixture, configured to direct visible light in a first direction;
an ultraviolet LED array, attached to said lighting fixture configured to direct ultraviolet light in a second direction, said second direction being a same direction or a different direction than said first direction;
a control unit attached to said lighting fixture, said control unit being electrically connected to said visible light source and programmed to control an intensity of light emitted from said visible light source, said control unit being electrically connected to said ultraviolet LED array and programmed to control an intensity of light emitted from said ultraviolet LED array.

2. The lighting fixture of claim 1, wherein said visible light source is an RGB LED array and said control unit is further programmed to control the color, hue, saturation, and time to shift from a first color to a second color of the visible light.

3. The lighting fixture of claim 1, wherein said visible light source is attached to a first surface of said lighting fixture, and said ultraviolet LED array is attached to a second surface of said lighting fixture, said first surface and said second surface being angularly displaced from each other.

4. The lighting fixture of claim 1, further comprising an ultraviolet shield, attached to said light fixture between said ultraviolet LED array and said visible light source, said ultraviolet shield preventing ultraviolet light from being directed in said first direction.

5. The lighting fixture of claim 1, wherein said first direction is a direction that illuminates a designated area, second direction is toward an airflow source.

6. The lighting fixture of claim 1, wherein said ultraviolet LED array emits ultraviolet light in at least one of the ultraviolet-B, 280 to 315 nm range, and the ultraviolet-C, 200 to 280 nm, range.

7. The lighting fixture of claim 1, wherein said ultraviolet LED array emits germ killing ultraviolet light.

8. The lighting fixture of claim 1, further comprising a smoke detector device, for sensing whether smoke is in the air about said fixture, is connected to said control circuitry, said control circuitry providing an alarm signal when said smoke detector device senses smoke.

9. A lighting fixture system for use in the passenger cabin of at least one of an airplane, a train and a bus, said lighting fixture system comprising:
an operator interface for controlling a plurality of lighting fixtures in said lighting fixture system, said plurality of lighting fixtures each comprising:
a housing;
a visual light source for providing visual lighting to the passenger cabin, said visual light source attached to said housing;
an ultraviolet LED array providing germicide ultraviolet light in the direction of an air vent in said passenger cabin, said ultraviolet LED array attached to said housing; and
a control module in electronic communication with said operator interface, said control module mounted in said housing, said control module being electrically connected to said visible light source and programmed to control an intensity of light emitted from said visible light source in accordance with first electronic communications with said operator interface, said control unit being electrically connected to said ultraviolet LED array and programmed to control an intensity of light emitted from said ultraviolet LED array in accordance with second electronic communications from said operator interface.

10. The lighting fixture system of claim 9, wherein said visual light source is a RGB LED array or a RGBW LED array, and wherein said control module is further programmed to control color, hue, saturation, and an amount of time to shift from a first color to a second color of visible light.

11. The lighting fixture system of claim 9, wherein said plurality of lighting fixtures each further comprises an ultraviolet shield, attached to the housing between said ultraviolet LED array and said visible light source, said ultraviolet shielding ultraviolet light from being directed into said passenger cabin.

12. The lighting fixture system of claim 9, wherein said plurality of lighting fixtures each further comprises a first surface on said housing where said visible light source is attached and a second surface on said housing where said ultraviolet LED array is attached, said first surface and said second surface being angularly displaced from each other.

13. The lighting fixture system of claim 9, wherein said germicide ultraviolet light is in at least one of the ultraviolet-B, 280 to 315 nm range, and the ultraviolet-C , 100 to 280 nm, range.

14. The lighting fixture system of claim 9, wherein said ultraviolet LED array is removably attached to said plurality of lighting fixtures.

15. A combination ultraviolet germicidal LED array and visible light LED array lighting fixture for use on a transportation vehicle, comprising:
a housing having a length and a first and a second outer surface;
an array of ultraviolet LEDs disposed on the first surface of said housing;
an array of RGB LEDs disposed on a second surface of said housing;
a control circuit electrically controlling said array of ultraviolet LEDs and said array of RGB LEDs, said control circuit comprising:
a microprocessor programmed to control said ultraviolet LEDs separately from said array of RGB LEDs,
a memory, electrically connected to said microprocessor, that stores data associated with a plurality of preprogrammed lighting configurations for said array of ultraviolet LEDs and said array of RGB LEDs; and
communication means, connected to said microprocessor, for communicating with a control panel.

16. The combination ultraviolet germicidal LED array and visible light LED array lighting fixture for use on a transportation vehicle of claim 15, wherein said array of ultraviolet LEDs are in the form of a detachable module that is detachably connected to said housing.

17. The combination ultraviolet germicidal LED array and visible light LED array lighting fixture for use on a transportation vehicle of claim 15, wherein said first surface and said second surface are canted with respect to each other.

18. The combination ultraviolet germicidal LED array and visible light LED array lighting fixture for use on a transportation vehicle of claim 15, further comprising a shield placed between said array of ultraviolet LEDs and said array of RGB LEDS, said shield being opaque to ultraviolet light.

19. The combination ultraviolet germicidal LED array and visible light LED array lighting fixture for use on a transportation vehicle of claim 15, wherein said communication means comprises at least one wire from said control panel to a combination ultraviolet germicidal LED and visible light LED array lighting fixture.

20. The combination ultraviolet germicidal LED array and visible light LED array lighting fixture for use on a transportation vehicle of claim 15, wherein said combination ultraviolet germicidal LED array and visible light LED array lighting fixture is mounted substantially near an output of an air circulation system in said transport vehicle such that ultraviolet light emitted from said array of ultraviolet LEDS impinges on said output of said air circulation system.
